(19) United States
(12) Patent Application Publication
(10) Pub. No.: US 2025/0291564 A1
(43) Pub. Date: Sep. 18, 2025

(54) SOFTWARE ARCHITECTURE RECONSTRUCTION METHODS FOR MICROSERVICE SYSTEMS

(71) Applicants: Arizona Board of Regents on Behalf of the University of Arizona, Tucson, AZ (US); Czech University BRNO University of Technology, Brno-stred (CZ); Baylor University, Waco, TX (US)

(72) Inventors: Tomas CERNY, Tucson, AZ (US); David KOZAK, Brno-stred (CZ); Amr Elsayed Mohamed Abdelfattah Saad AISHA, Waco, TX (US)

(21) Appl. No.: 19/074,164

(22) Filed: Mar. 7, 2025

Related U.S. Application Data
(60) Provisional application No. 63/564,248, filed on Mar. 12, 2024.

(51) Int. Cl. G06F 8/41

(52) U.S. Cl. CPC G06F 8/433

(57) ABSTRACT

Methods and systems for analyzing architectures of microservice systems are described. An example method includes generating, based on an analysis of a bytecode of a microservice system, a graph-based intermediate representation that models control-flow and data-flow dependencies between a plurality of microservices of the microservice system. The method then includes parsing the graph-based intermediate representation to extract one or more components of the microservice system, and generating, based on the one or more components and a list of attributes for each of the plurality of microservices, a service dependency graph that represents a service view of the microservice system and a context map that represents a domain view of the microservice system. The method additionally includes visualizing, based on the service view and the domain view, an architecture of the microservice system. An example system includes one or more processors that are configured to implement the above-described method.

### CROSS-REFERENCE TO RELATED APPLICATION

This patent document claims priority to and benefits of U.S. Provisional Patent Application No. 63/564,248, entitled “SOFTWARE ARCHITECTURE RECONSTRUCTION FOR MICROSERVICE SYSTEMS,” and filed on Mar. 12, 2024. The entire content of the before-mentioned patent application is incorporated by reference as part of the disclosure of this patent document.

### TECHNICAL FIELD

This document generally related to microservice systems, and more particularly, to software architecture reconstruction for microservice systems.

### BACKGROUND

Microservices are an architectural and organizational approach to software development where software is composed of small independent services that communicate over well-defined APIs. These services are owned by small, self-contained teams. Microservices architectures make applications easier to scale and faster to develop, enabling innovation and accelerating time-to-market for new features.

### SUMMARY

Microservices are the mainstream architecture when designing cloud-native systems. The performance and elastic scalability of such systems are the main attraction for many vendors. Recent advancements improving microservice initialization times are related to the ahead-of-time compilation, which produces self-contained executables, significantly reducing load times. Despite recent advancements and various benefits of cloud-native systems, the evolution of such systems might be threatened by a missing system-centered view. This gap has been addressed by performing Software Architecture Reconstruction (SAR), a process essential for understanding, maintaining, and evolving software systems. Some embodiments of the disclosed technology provide methods that employ instruments used to produce self-contained executables for microservices to be utilized for SAR, producing system-centered views. An example implementation is a proof of concept tool, MicroGraal, for the Java Platform, which is assessed through a case study involving a third-party microservice system benchmark.

In an example aspect, a method of analyzing architectures of microservice systems that includes a plurality of microservices is disclosed. The method includes generating, based on an analysis of a bytecode of a microservice system, a graph-based intermediate representation that models control-flow and data-flow dependencies between a plurality of microservices of the microservice system. The method then includes parsing the graph-based intermediate representation to extract one or more components of the microservice system, and generating, based on the one or more components and a list of attributes for each of the plurality of microservices, a service dependency graph that represents a service view of the microservice system and a context map that represents a domain view of the microservice system. The method further includes visualizing, based on the service view and the domain view, an architecture of the microservice system.

In another example aspect, a system for analyzing architectures of microservice systems is disclosed. The system includes one or more processors and a microservice system that includes a plurality of microservices that interact to perform an overall application function, each microservice of the plurality of microservices being associated with at least one endpoint and configured to perform a partial function of the overall application function, and the at least one endpoint of a corresponding microservice enabling a user or another microservice to interact with the corresponding microservice. In this system, the one or more processors are configured to parse an intermediate representation to extract one or more components of the microservice system, and generate, based on the one or more components, a service dependency graph that represents a service view of the microservice system and a context map that represents a domain view of the microservice system. In this example system, the intermediate representation is based on an analysis of a bytecode of the microservice system, and the one or more processors are further configured to visualize, based on the service view and the domain view, an architecture of the microservice system.

In yet another example aspect, an apparatus comprising a memory and a processor that implements the above-described method is disclosed.

In yet another example aspect, the above-described method may be embodied as processor-executable code and may be stored on a non-transitory computer-readable program medium.

The above and other aspects and features of the disclosed technology are described in greater detail in the drawings, the description and the claims.

### BRIEF DESCRIPTION OF THE DRAWINGS

FIG. 1 illustrates an example of a visualized Graal intermediate representation.

FIGS. 2A-2C illustrate the phases in the described methodology where each microservice's Native Image is processed to detect high-level constructs in the Graal IR and then connections across microservices are linked to derive intermediate representations of architectural views, which are then visualized.

FIG. 3 illustrates a service dependency graph for the Train-Ticket benchmark.

FIG. 4 illustrates a sub-context map for the Train-Ticket benchmark.

FIG. 5 illustrates a flowchart of an example method for transforming a codebase repository into a reconstructed software architecture.

FIG. 6 illustrates a flowchart of an example method for analyzing an architecture of a microservice system.

FIG. 7 is a block diagram illustrating an example system configured to implement embodiments of the disclosed technology.

### DETAILED DESCRIPTION

Devices, systems, and methods for analyzing an architecture of a microservice system are described. Section headings are used in the present document to improve readability of the description and do not in any way limit the discussion or the embodiments (and/or implementations) to the respective sections only.

### I. Introduction

Using microservice architecture has been the de-facto standard approach in the industry for the last decade to build cloud-native systems. The microservice architecture provides considerable advantages to developers, including flexibility, scalability, and facilitated deployment, as discrete parts of the system can be independently designed, developed, and deployed.

However, developing and evolving microservice systems are also known to be complex and error-prone. The distributed nature of microservices makes it difficult to access the holistic, centralized view of the system. This statement is true for a static code analysis approach and for the developers contributing to the system, both of which typically analyze only a single microservice at a time. We contend that, in the era of microservices, traditional static code analysis methods are inadequate, as the majority of issues arise from the interactions between distinct microservices within the system and thus remain undetected by these conventional approaches.

To address this challenge, Software Architecture Reconstruction (SAR) methods specifically tailored for microservices have been proposed. SAR techniques for microservices facilitate a deeper understanding of the system by generating high-level architectural views that concentrate on distinct facets, such as the service view which describes the interaction among microservices and the domain view which illustrates involved domain data. The SAR process is also a necessary precondition for automated system assessments, such as detecting microservice design smells (i.e., cyclic dependencies, etc.) apparent from the system's holistic perspective.

The manual execution of SAR is both time-consuming and susceptible to errors. Consequently, researchers have proposed methodologies that employ static analysis of the source code to address these challenges. However, there are instances where developers may not have access to the source code, such as if there are legal constraints or if the analysis is conducted during deployment. Fortunately, the compiled representation of numerous programming languages, including Java bytecode, retains sufficient information to facilitate static analysis.

A successful SAR approach for microservices should accommodate recent advancements in cloud-native infrastructure, where faster startup times and reduced memory footprints are demanded. Specifically, there is a surge in the popularity of ahead-of-time (AOT) compilation. GraalVM introduced a component: Native Image, which is a compiler for Java that uses a combination of points-to analysis, AOT compilation, and class initialization at build time to create self-contained binaries which start quickly and execute with a lower memory footprint compared to running on the Java Virtual Machine (JVM). These capabilities make it a perfect prospective for cloud environments.

The disclosed embodiments consider the SAR of microservice systems by utilizing Native Images of particular microservices. By developing an analyzer on the foundation of a widely adopted, industry-ready compiler, the described embodiments provide added value to the Native Image community without necessitating the integration of additional tools into their pipelines. In addition to such advancements, information extracted from Native Images can be utilized by human experts through an interactive visual perspective for the service view and domain view. These two views combine to provide a holistic view of the system.

Embodiments of the disclosed technology provide, inter alia, the following advantages and benefits:
providing a novel methodology for a static analysis-based SAR for microservice systems using GraalVM Native Image to extract the service view and the domain view.
producing a proof-of-concept tool MicroGraal, targeting SAR for Java-bases microservices, interactively visualizing two architectural views to aid developers in understanding their systems.
demonstrating the approach through a case study performed on a well-established microservice benchmark.

### II. Background

This section briefly introduces the SAR process, static analysis, and Graal VM.

### A. Software Architecture Reconstruction

Software Architecture Reconstruction has been well detailed as “the process by which the architecture of an implemented system is obtained from the existing system”. It is meant for evaluating the conformance of the as-built to the as-documented architecture, reconstruction documentation, and analysis and comprehension of the system architecture. This enables its modification of the architecture to satisfy new requirements and eliminate existing software deficiencies.

The reconstruction process aims to uncover particular viewpoints on the software architecture. Among the examples, particular perspectives, or so-called views, are domain concerns describing the entities of the system along with the data sources, the system's implementation and operation technology aspect; service operators describing the service models that specify microservices, interfaces, and endpoints (i.e., service view realized as service dependency graph); and the operation focusing on service deployment and infrastructure, such as containerization, service discovery, and monitoring.

The construction process has four phases. It first aims to gather the necessary artifacts that serve as information input to the process, which might be relevant to the particular perspective or view of the system. Next, the canonical representation of the perspective is constructed. Some initial intermediate representation is formed, and in the next phase, particular perspectives are combined to reconstruct more holistic architectural details. Finally, this holistic detail is an instrument serving for analysis to provide insight about a system. These questions can relate to various concerns, including domain models, dependencies, interaction, design quality, privacy, or security aspects of the system.

### B. Static Analysis

Static analysis is typically performed on program code to inspect it without executing it. The analysis process provides an understanding of the code structure to ensure that the program code and its design follow expected quality or standards. It can be involved throughout software development to detect common errors or poor coding practices. Typically, code quality tools use static analysis to build program intermediate representation, which they use for pattern marching. These patterns typically represent an anti-pattern associated with common design errors or poor coding practices.

Static analysis can operate on source code or even the bytecode or binary. Most commonly, for source code input, parsers that produce program graph representations are used. For example, Abstract Syntax Trees (AST), Control-Flow Graphs (CFG), and Program Dependency Graphs (PDG).

Companies dealing with software security testing wade into the “no source available” pool, which might be the alternative input to source code. Bytecode is compiled, high-level, machine-independent code that is meant to run on a virtual machine, such as the Java VM or the.NET CLR. It is possible to decompile bytecode back to the source code to run source code analysis. However, typically, when we have access to source code, we also have access to the codebase, which contains build, deployment (i.e., docker files), and configuration files not necessarily available in bytecode analysis.

However, not all platforms compile into a bytecode and produce a binary. It can still be analyzed but with greater difficulty while uncovering less detail about the original code structures. It is also known as binary analysis or code review.

Most current static analysis approaches remain distant from microservices, as they consider a single program or codebase, and apart from this, microservices build on well-established standards encapsulated through components. However, typically, static analysis practice looks at the low-level language constructs despite the current higher-level programming practices in various cloud-based or enterprise-based development frameworks. Thus, to properly and holistically perform static analysis for microservice systems, the analysis needs to recognize higher-level programming constructs such as components, endpoints, remote calls, etc.

### C. GraalVM

GraalVM is a Java Virtual Machine (JVM) that uses the Graal compiler as the just-in-time (JIT) compiler. Graal is a compiler for Java written in Java that was designed to be extensible and maintainable, thus making it easier to develop complex optimizations and to access and comprehend the source code of the compiler using modern, integrated development environments. It is also possible to use Truffle to integrate other language runtimes for GraalVM, such as Python, Javascript, and R.

### 1) Graal Intermediate Representation:

Graal Intermediate Representation (IR) is a graph-based representation that models both the control-flow and the data-flow dependencies between nodes. It is in static single-assignment (SSA) form, i.e., all values have unique static definitions. Using the SSA form speeds up many compiler optimizations, such as constant propagation or dead code elimination. The nodes in the IR are separated into two groups: fixed and floating. Fixed nodes have a strict ordering based on the control flow of the program. Floating nodes represent values; they float around the fixed nodes and are only loosely coupled to them. This design makes it easier to apply optimizations such as global value numbering.

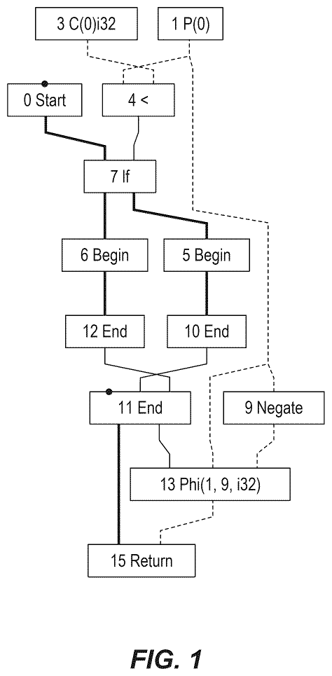

In an example, consider the structure of Graal IR using the example code snipped in Listing 1 shown below. The method abs computes the absolute value of the parameter x. The corresponding Graal IR of the method can be found in FIG. 1, where the control flow of the program is denoted by the bolded edges connecting fixed nodes and data flow is denoted by the dashed edges connecting floating nodes. Notice the SSA phi node merging the two values of res coming from different branches.

Listing 1: Code snippet sample illustrated as Graal IR in FIG. 1.

```
void abs (int x) {
  int res;
  if (x >= 0) {
    res = x;
  } else {
    res = −x;
  }
  return res;
}
```

The analysis is based on the Graal IR as it is more high-level compared to accessing the bytecode directly, and we can leverage the whole infrastructure of the compiler to our advantage. The alternative to this approach is to consider ASTs, tree-like structures that represent the syntactic structure of the program.

Graal IR, on the other hand, is a more regular representation of the program that is closer to the machine code. It is generated from the bytecode by the Graal compiler and is used for further analysis, optimization, and code generation. Graal IR is designed to be machine-independent and can be compiled via different backends to generate machine code for different platforms. This enables bytecode meant for deployment to be analyzed.

### 2) GraalVM Native Image:

GraalVM Native Image (NI) is a compiler for Java that uses a combination of points-to analysis, ahead-of-time (AOT) compilation, and heap snapshotting to compile applications into standalone binaries that have a significantly faster startup time and lower memory footprint compared to running on the JVM. NI works under the closed-world assumption, i.e., all application classes must be accessible during the compilation. While restrictive, this assumption allows more aggressive optimizations. Dynamic features of Java, such as reflection, have to be explicitly registered.

### III. Related Work

Several studies have anticipated System Architecture Reconstruction (SAR) for microservice systems, but they differ in their approaches. Some methods leverage the artifacts produced during runtime to perform dynamic analysis, e.g., they analyze telemetry data to identify inter-service communication patterns and construct a service dependency graph (SDG), which is then used to detect architectural smells in the system. However, these approaches do not support the context map of the system, and building the SDG from logged traces requires the system to be operational.

Therefore, some other approaches used certain artifacts that are generated and available during the development phase to implement hybrid analysis approaches. For instance, static and dynamic analysis techniques can be combined to extract the architecture of REST-based microservice systems, e.g., by extracting static information using Swagger documentation to generate API descriptions of services and analyzed dynamic data from log files, including incoming and outgoing requests of each service instance.

Other approaches have taken a different direction and focused on manual analysis to build various models to combine. One other alternative was to use static analysis, e.g., examining the source code of microservice-based systems. However, their method used Java reflection APIs, which limited their ability to only analyze Java-implemented systems. Although these methods successfully reconstructed the architecture of systems, they are limited to specific machines and languages, which restricts their potential use in heterogeneous microservice systems.

Diving deeper into IR-based approaches, existing implementations have proposed a static analysis technique, Relative Static Structure Analyzers (ReSSA), that shows great potential to transform static code analysis practices. That approach operates with component types instead of low-level programming constructs, constructing and utilizing an IR called Language-Agnostic Abstract-Syntax Tree (LAAST). LAAST representation is constructed from the source code's AST. ReSSA introduced a set of generalized parsers to detect specific component types. These parsers can be system-specific parsers to better cope with platform differences. The study demonstrated a unified identification approach to determine system data entities and endpoints for constructing SDG and the context map from microservice-based systems.

The disclosed embodiments share similarities with ReSSA's approach in utilizing an IR, but it has some significant differences. ReSSA's technique requires access to the source code of the system for analysis, which may not always be feasible, particularly for support teams that only have access to the deployable bytecode of the system. In contrast, our approach operates over the Graal IR, which is constructed from the bytecode. Additionally, ReSSA employs LAAST, a proprietary intermediate representation that lacks sufficient support and requires considerable effort to support other languages and fix issues. As they mentioned that the user is also responsible for handling numerous edge cases in the structure, such as the various possible ways the endpoint URL could be defined in the call. The described implementations employ Graal IR, which has the potential for industry usage and support. It also captures the semantics of the system, not just the syntax, which makes it clearer and more promising for extracting information in heterogeneous microservice systems. Finally, ReSSA necessitates several parsers and specifications to extract the required information.

### IV. Methodology

For some embodiments of the microservice-aware SAR process, it is assumed that “no source” is available and bytecode analysis from Graal IR is used as the input. Assumptions are made that microservices use best practice design and are developed using well-established frameworks which make use of components and high-level design constructs. These are provided by current frameworks, as it facilitates faster development. It also enables generalization when performing SAR, which can reduce to matching components and high-level constructs and their properties.

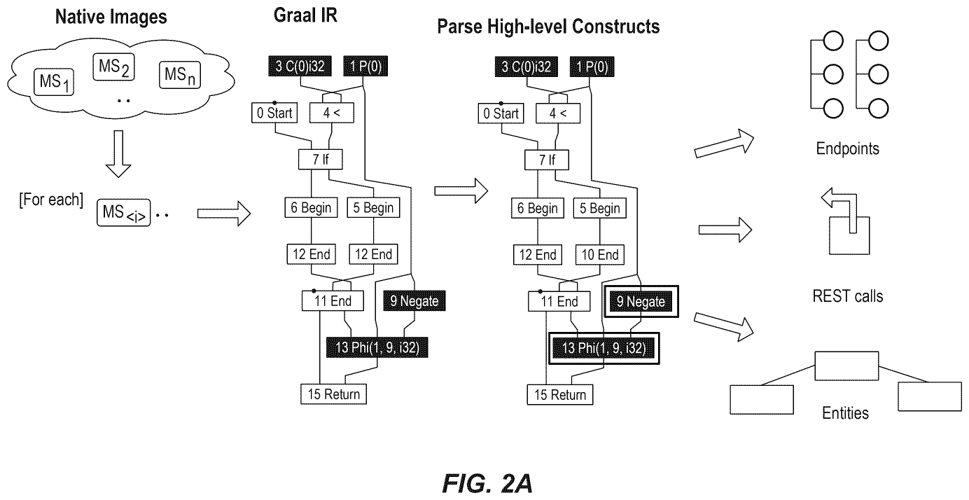

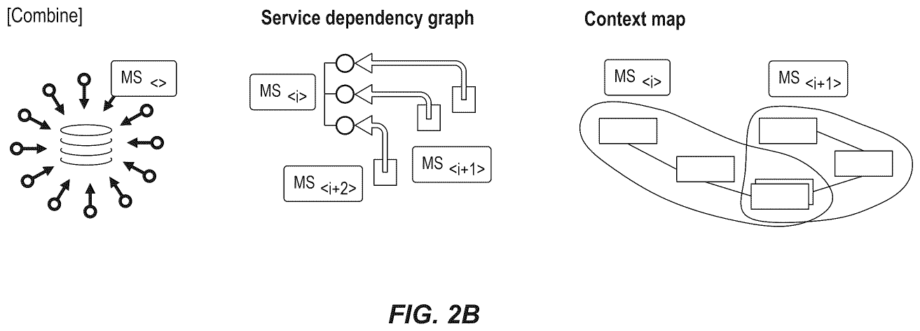

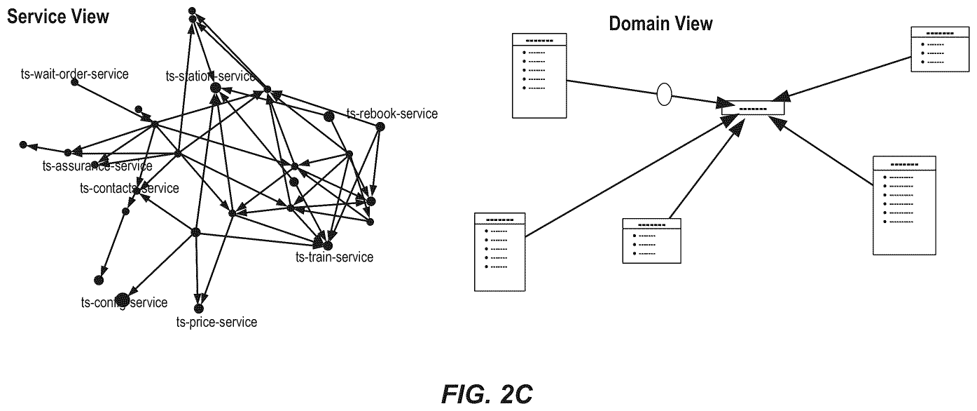

FIGS. 2A-2C illustrates the three phases in some embodiments: (1) analyze the Graal IR for every single microservice and detect high-level constructs (in FIG. 2A), (2) using the high-level constructs, we reason about the inter-microservice dependencies and build IR for two architectural views (in FIG. 2B), and (3) visualize the particular architectural perspectives of the system (in FIG. 2C).

In the first phase (“extraction”), to analyze the bytecode of a single microservice via Graal IR, the Graal API is used to parse particular components and high-level constructs that are commonly used across development frameworks. In particular, components like the entities, services, and controllers are recognized and extracted with their details (i.e., endpoints, attributes, etc.). It is also necessary to parse remote REST calls to other microservices within the system, which are necessary to detect dependencies between microservices. Section IV-A gives more details.

Next, in phase two (“linking”), the data extracted from phase 1 is transformed for the creation of the service dependency graph and context map, which represent the service view and the domain view. In the construction of the service dependency graph, REST calls are bound to endpoints via partial signature matching.

In order to provide a more clear representation of the domain view of the system, entities across microservices are combined based on their similarity in names and/or attributes. It is common for microservices to share entity variations across their microservice bounded context. By combining them, we greatly clarify the structure of the system. More details on how the data is merged are given in Section IV-B.

Finally, in phase three (“visualization”), the constructed architectural perspective IRs are used for visualizing the constructed architectural perspectives. Our focus is the service view (service dependency graph) and the domain view (context map formed from individual entities of bounded contexts). The service dependency graph illustrates communication across microservices. It enables users to obtain detailed insights into the system without examining the code directly. It also illustrates dependencies and potential architectural change propagation. We detail this in Section IV-C.

The described methodology provides a comprehensive solution for analyzing and visualizing complex microservice systems via GraalVM Native Image in order to enable a high-level understanding of a system without delving into the codebase. As a result, informed decision-making and system management can be accomplished at a high-level abstraction of the system.

A proof-of-concept of our methodology has been implemented for practical assessments. The resulting MicroGraal tool allows us to assess the concept feasibility for microservices implemented using the Java Platform. It also serves as a reference implementation for SAR on GraalVM Native Image and will enable replicating our findings in this work. The open-source is shared with the community in the uncensored version of this paper. The existence of the MicroGraal tool allows us to illustrate examples in each next sub-section that details the phases of our methodology.

### A. Extraction of Data

To extract the data necessary to derive particular architectural perspectives-the service and domain views-we operate with the Graal IR of each individual microservice in the system. We first assume that the two views are represented by components of development frameworks. Then we analyze each microservice class to identify such components and other high-level constructs. This allows our methodology to be reused across different systems.

To operate and debug information extraction from Graal IR, Oracle developed the Ideal Graph Visualizer (IGV) (see FIG. 1), which can help with matching nodes necessary to identify high-level construct' patterns in Graal IR. In the following text, we introduce the extraction of important high-level constructs from Graal IR. In particular, we look to extract REST calls, endpoints, and data entities. Given GraalVM primarily targets the Java Platform, we illustrate the example application on the Java platform.

### 1) REST Call Extraction:

In order to identify which nodes in the Graal IR should be traversed to extract pieces of REST call information, we can use Graal's Meta and Compiler APIs, where an array of patterns were identified, each pattern addressing a frequently observed REST call use case. A pattern in this case being any methods which have a similar Graal IR tree to one another. If the trees are the same or similar it means the code within the methods are the same or similar in every way (content, syntax, and structure, etc.). The process to identify these patterns involves inspecting the Graal IR in IGV, comparing it with source code examples, and determining which types of nodes contain specific information based on the code structure. Graal IR can exhibit a virtually infinite range of structures due to the unique composition of each method and its contents, as well as the inherently complex mapping from source code to compiler-level representations. This complexity arises from the diverse ways programming constructs can be expressed, the presence of various language features, and the compiler's role in optimizing and transforming the code particularly in the lexical, syntactical, and semantic analysis stages of the compilation process. Consequently, the methodology developed in this research focuses on capturing the most prevalent patterns of REST calls encountered in the research while providing the flexibility for future researchers to extend the approach to additional tree structure patterns.

Given the Java specifics, the process begins by retrieving a list of class objects from the microservice's ImageClassLoader, which is then filtered to only include class objects belonging to the microservice's base package. From there, every class is broken down into its declared methods. For every method, a StructuredGraph object can be pulled out. From this, the tree was traversed to locate the node which contains the RestTemplate object commonly used for REST calls. This object indicates the node representing the line of source code that makes the REST call.

The patterns we developed assume there is only one RestTemplate call in the method. From there, the patterns previously determined by utilizing IGV can be implemented and details can be extracted, such as the URL of the HTTP request, the type of HTTP request (GET, PUT, etc.), the return type of the REST call as well as if it were a collection of that type, and what combination of class and method the call was being made in. The details of each REST call are stored in a custom RestCall object respectively and appended to the list of REST calls for that given microservice for the Graal analysis system to handle.

### 2) Endpoint Extraction:

Graal's Meta and Compiler APIs provide extensive utilities for extracting endpoints from controllers. An AnalysisMethod object, which can be traversed for extracting endpoint data, was used for fetching HTTP requests, return types, and parameters. To capture the return type for an endpoint, the Reflection API was adopted as an intermediate step between Graal IR and our custom objects. For other required attributes, several conditions were handled based on Spring's annotations for mapping. For example, the RequestMapping annotation required additional implementation to ensure the target endpoint path was accurate. Upon GraalVM compilation, a single CSV file containing each controller's endpoints for a provided microservice is generated.

### 3) Entity Extraction:

To extract the entities from a given microservice, each class, along with the methods and the fields for that class, is considered. The class, fields, and methods are all extracted from their internal representation used by the Graal compiler. In the case of many Java frameworks, the classes, methods, and fields can be checked for annotations which indicate an entity along with its details. This various annotations coming from the Java Persistence API, Spring, Lombok, or other frameworks can be considered along with methods generated which are consistent with an entity class. In some cases, the methods must be checked because annotations have been processed during compilation before Graal's IR analysis begins. Once an entity class has been identified, the entity name as well as each field, including the field name, the type, and all annotations with particular settings, are extracted into an intermediate representation for a given microservice; we use JSON format for this representation.

When a microservice is finished being analyzed and the extraction of information is complete, a CSV file containing all the extracted REST calls and their details is created, and the same is created for endpoints. A third file is also generated—a JSON file with all entities extricated as well as their respective fields and annotations. These files are read by phase 2 for the creation of domain and service views.

### B. Transformation of Data

Using the high-level structures, constructs, components, and their contextual details extracted using Native Image and Graal IR, we next pay attention to the relationships between these extracts. The aim of this consideration is to form particular system views such as the domain and the service view. In particular, we construct the context map and service dependency graphs which serve as illustrations of these views. For the transformation of the data process, users must supply a JSON list of microservices, which for every microservice includes the microservice name, base package, and base directory. As discussed in further sections, our utilized microservice benchmark was manually input into our JSON file.

### 1) Service Dependency Graph:

Extracting REST calls from each microservice includes the URL, HTTP method, destination microservice (if present in the URL), and if there is a body parameter. Endpoint parsing will have subsequent information such as the HTTP method, the URL, and parameter types. Therefore the linking can be achieved using the URL, HTTP method, microservice name (if it is able to be parsed from the REST Call), and if there is a body parameter to match the REST call to the endpoint in the microservice. One thing to note is that the URL is matched from a REST call to an endpoint without the use of path parameters. This is because of the limitation of finding the names of the path parameters from the REST Calls. Therefore, the matching of URLs only match the hard-coded parts of the URL and deletes the path variables. The URL is a complete match only on the hard-coded sections of the string.

After the linking process completes, the service dependency graph is complete and stored as a JSON with all the microservices listed as nodes, and all REST call/endpoint pairs placed within their respective links for the visualizer to read.

### 2) Context Map:

In order to transform the extracted data entities into a more comprehensive perspective, bounded contexts data models are formed and used to derive a system context map. Extracted entities are associated according to relationships to form data models within each microservice. In addition, inter-service entity models are merged based on entity similarities.

The process considers every microservice we point to via the configuration file that phase 2 requires. In the case of Java, each microservice is packaged as a Java Archive that has a well-defined structure of compiled classes libraries, and resources, which needs to be accessed when converting to the Graal IR and analyzing it (i.e., /BOOT-INF folder).

The entities from every microservice are extracted and collected to serve as references for possible parts of a relationship between entities. Every microservice is iterated over again, extracting the fields from every entity within a microservice. These fields are compared against the list of entities extracted previously to check for a type match, which indicates a relationship between the two entities. If there is a match, the multiplicity of the relationship is recorded based on the number of fields and if those fields are a collection. Furthermore, the relationships extracted are one-sided (A to B is different from B to A) and thus have to be combined to form a full representation of the multiplicities of that relationship.

The following step is to merge data models across microservices to create a context map for the entire system. Since multiple microservices may operate in the same domain, some bounded contexts may contain the same entities. Additionally, different bounded contexts may have different purposes for the entities they share, which means they may retain different fields from each other. To accomplish this, the following merging rules are applied to the entities and their fields:

Entities are merged by determining if they have the same or similar names. In an example, it utilizes the WordNet project to detect similarities in names.

Fields that have the same data type and the same or similar names in the merged entity are merged. Non-matching fields from both entities can be appended to the merged entity. Finally, the list of merged entities and their relationships is used to create a JSON schema to represent an intermediate representation of the context map.

### C. Visualization of Data

The architectural view IRs of derived views would not serve much purpose unless constructed information becomes easily accessible. For this reason, we consider interactive visualizations that provide capabilities for reconstructing a service dependency graph and context map.

### 1) Service Dependency Graph:

With the formed service dependency graph intermediate representation, it is possible to approach visualization. A collection of nodes, node labels, and directed links represent this graph. The nodes represent individual microservices, and the labels above each node display the name of the microservice.

The users may interact and select each node and open a window that displays information about the microservice, such as that microservice's dependents and dependencies. The dependents of, for example, microservice A, are any microservice that makes calls to microservice A. The dependencies of A would be any microservice that A makes outbound calls to. Microservices that make no calls and receive no calls to other microservices have no links and thus float around the graph.

The directed links are a visual representation that show the direction of the REST call from source to target. When the user clicks on a link, a window pops up that lists the source microservice, the target microservice, and all the REST calls that occur from source to target.

The application also allows users to grab nodes and drag them around the three-dimensional (3D) space, as well as pan and rotate the camera to better orient themselves and view the graph from different perspectives.

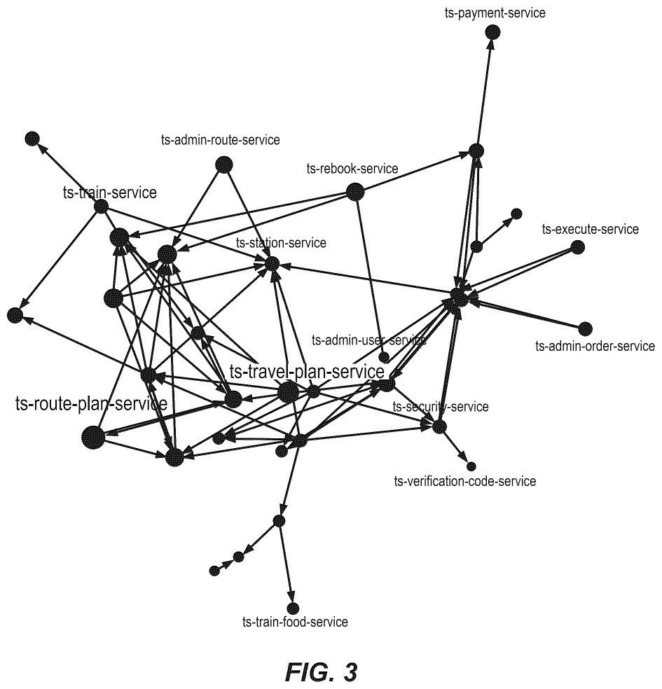

A snapshot of service dependency graph reconstruction is visible in FIG. 3.

### 2) Context and Sub-Context Maps:

Based on the analysis of data entities, the JSON-based context map is visualized in a web-accessible (react-force-graph-3d and three.js) format. Once processed, all context map entities are displayed as CSS3DObject nodes in a 3D, customized with each entity's associated fields and types. Links between nodes are contextual and hoverable with the cursor, revealing the multiplicities between different entities.

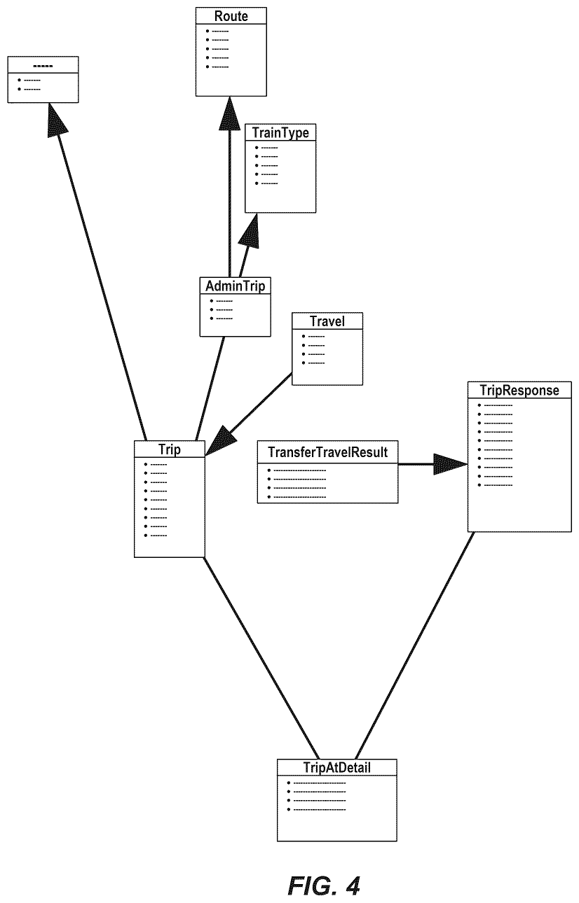

Our interactive visualization allows for creating sub-context maps by selecting certain microservices. This assists practitioners in understanding how a microservice's direct neighbors and data model overlap with dependencies. The this feature is beneficial for use cases where a provided system contains a significant number of entities and microservices. An example of a sub-context map is illustrated in FIG. 4, and includes the following microservices: ts-travel-service, ts-travel2-service, ts-travel-plan-service, ts-common.

### V. Case Study

To assess the reliability of our SAR process, we have implemented a prototype tool MicroGraal following our methodology. This prototype was prioritized towards components using the Java Spring Platform, which is well-adopted in the industry. In addition, we utilize a fork of GraalVM Native Image as the base for our analyzer because the AOT nature of Native Image allows us to access the whole compiled application, extract the Graal IR out of the relevant methods, and perform static analysis on top of them.

For the assessment, we utilized a well-established community microservice benchmark called train-ticket. Train-ticket is comprised of microservices that were devised by different frameworks and languages, such as Java, NodeJS, Python, and Go. Based on our static analysis method, we only assessed Java Spring Boot microservices, and all other microservices were excluded from our analysis. As a result, 42 Java microservices from train-ticket v1.0.0⁵ were considered in our analysis.

### A. Reliability of GraalVM

In our study, we ensured the reliability of our approach by conducting a manual analysis of the train-ticket benchmark. This manual analysis process involved three authors, where two authors extracted the data and one validated the data by examining the source code. Additionally, a tool that implemented source code-based analysis to achieve automated SAR was used. This tool was run on the same version of the benchmark that we examined in this case study and compared its results with ours in the following subsections. The service dependency graph and context map for the testing system were created, taking into account several special cases specific to the Java Spring Framework. Our generated dataset contains information on the extraction of entities, where we also performed a statistical evaluation of the given components in the train-ticket system.

### B. Service Dependency Graph

Our prototype was executed to produce the service dependency graph from the benchmark by analyzing REST calls, endpoints, and their connections. The outcomes of the manual process, the proposed method, and the source code-based tool are presented in Table I. This table provides a comparison of the number of calls and endpoints and how they collaborate in constructing the service dependency graph.

TABLE I
Service Dependency Graph Data Analysis

| | Approaches | | |
|---|---|---|---|
| Numbers | Manual | MicroGraal | Rel. Tool |
| REST Calls | 146 | 146 | 146 |
| Endpoints | 261 | 261 | 261 |
| Request Pairs in SDG | 142 | 123 | 114 |
| Links in SDG | 90 | 82 | 82 |

Our analysis depicts that our prototype successfully extracted all REST calls and endpoints from the system. It is worth noting, 4 of the REST calls have URLs that point to nonexistent endpoints in the system. In terms of the number of calls participating in the service dependency graph, our prototype missed 19 pairs of calls and endpoints that were expected to be present in the service dependency graph. However, these 19 pairs did not impact the number of links between microservices. Our prototype was able to extract 82 out of the 90 links in the service dependency graph, as each link can contain multiple calls between the involved microservices.

A more thorough investigation into the 19 missed pairs reveals that 11 of them were not captured because their URLs were assigned to a variable within a conditional branch (i.e., if-else), which our prototype did not cover. Additionally, the remaining 8 pairs were not formed because their calls contained the body parameter in a pattern that our prototype was not designed to handle. Moreover, the 8 missing service dependency graph links were a result of the previously mentioned missed pairs.

Comparing the results with those of a source-code-based tool, we found that we were able to extract all the endpoints and calls, and both approaches identified the same number of 82 links in the service dependency graph. However, our method showed improvement in the number of matched call/endpoints pairs in the service dependency graph, as it was able to extract 9 more pairs than the source-code approach.

### C. Context Map

In the constructed context map analysis, our prototype was utilized to generate a context map from the benchmark by extracting entities and their relationships with each other. The outcomes of the manual process, the proposed approach, and the source code-based tool are presented in Table II. This table provides a comparison of the entities and relationships in both the bounded context and in the context map after the merge process is executed.

The analysis of the context map data indicates that our prototype was able to construct a complete context map in terms of the number of entities and relationships, except for one entity that was missed across all microservices. However, this entity did not contain any relationships and was identified as merged in the manual analysis, so it did not impact the resulting context map.

Upon inspecting the context map data, we found that the ts-common and ts-delivery-service utility packages were incompletely parsed due to compatibility issues between the provided JAR and native image. As a result, it was not possible to retrieve entity fields within these microservices and they were omitted. However, the entity names remained available and were used to identify links between them and other microservices' entities in the system. The missed entity was the Delivery entity, which was not identified. However, since ts-delivery-service did not participate in any relationships, it did not affect the analysis. Moreover, although the VerifyResult entity was extracted, it was extracted from the ts-rebook-service microservice project, where the Maven file was configured to compile its file, and not from the microservice where it was defined, ts-common. Using this data, we were able to construct a holistic context map that includes entity attributes, entity names, and multiplicities between entities.

When comparing our results with the source code-based tool, we observed improvements in all the extracted data. Specifically, the source code-based tool failed to construct a complete context map. It missed 4 relationships and 9 entities in the bounded context, while our prototype only missed one entity.

TABLE II
Context Map Data Analysis

| | Approaches | | |
|---|---|---|---|
| Numbers | Manual | MicroGraal | Rel. Tool |
| Entity Bounded Context | 117 | 116 | 108 |
| Relation Bounded Context | 43 | 43 | 39 |
| Entity Context Map | 84 | 84 | 76 |
| Relation Context Map | 24 | 24 | 20 |

When including our extraction of ts-common, our approach to extracting entities correctly extracts 116 of 117 entities and 43 of 43 relationships before the combination of entities as well as 84 of 84 entities and 24 of 24 relationships after the combination of entities. When using microservices that produce JARs that can be parsed by MicroGraal, our tool is 100% accurate when compared to manual analysis. Our approach identifies more entities and relationships both before and after the condensation of entities than the related source code analysis tool listed.

### VI. Discussion

Static analysis tools are commonly used by developers to assess the quality of their code and system design at an early stage. However, when it comes to microservice systems, these tools are still in their infancy and there is currently a market gap that needs to be addressed. By developing static analysis tools for microservice systems, we could greatly improve the overall quality of these systems.

To ensure effective static analysis, it is crucial for any tool to establish a robust intermediate representation of the system at the outset, regardless of the type of system being analyzed. This serves as a foundational step in achieving the goal of uncovering various architectural views through the Static Analysis Review process.

However, it is important to note that static analysis alone cannot provide a complete system-centered perspective. It is essential to consider other perspectives as well, such as the system runtime, dynamic analysis, infrastructure details, team organization, and the development process. Only by taking all these perspectives into account can we obtain a comprehensive understanding of the system and achieve our quality goals.

In the context of microservice systems, current tools prioritize dynamic analysis, such as OpenTracing, due to the ease of dealing with system polyglots. However, the management of system tracings introduces complexity and can only provide a black box perspective of the system. Furthermore, dynamic analysis requires user interaction or comprehensive testing to generate traces, and this does not come free of charge. Not many companies will prioritize visible (functional) system additions over invisible (quality) solutions, which could introduce technical debt and lead to architectural degradation.

Relying solely on dynamic analysis necessitates the use of infrastructure resources to test new versions of microservices. However, these tests may be limited in scope and may rely on outdated test suites, leading to the inefficient use of time and computational power. Moreover, such tests come with significant energy footprints. Requiring dynamic analysis tests for every new commit to a microservice can lead to prolonged periods between the introduction of errors and their identification. This inefficiency hampers the development process and can significantly impede the ability to address issues quickly and effectively.

Static analysis offers advantages to better cope with the previously mentioned setbacks because it does not require a running system to provide insights into the system's architecture, changes, and qualities. This makes it a closer and more accessible tool for developers, offering early feedback on code changes. By placing a single microservice in the context of other connected neighboring microservices, static analysis allows developers to reason about change propagation, impact, and implications. This approach can help mitigate ripple effects and identify potential issues early in the development cycle. Moreover, static analysis enables direct comparison to previous versions of the system, a capability that dynamic analysis does not possess. Overall, static analysis offers a powerful solution for managing complex microservice architectures and promoting high-quality software development practices.

Our work is foundational to the microservice-aware SAR as it demonstrates that static analysis can uncover reliable architectural views. The combination with GraalVM is a wise decision as GraalVM is not just a Java Platform. The integration of other language runtimes becomes possible with Truffle, which could potentially address the current greatest weakness of static analysis: its limited applicability to monoglot systems. Still, there is a long path as components across other frameworks would need to be recognized. It must also be seen in the context of low-level virtual machines, which are unsuitable for SAR as they operate with low-level constructs, especially in microservices, we require high-level constructs and framework components to properly reconstruct architectural views that reflect the actual code developers are familiar with.

### VII. Threats to Validity

### 1) Internal Validity:

The major drawback of the extraction and transformation of entities is that JAR files for microservices must be compatible with Native Image in order to be properly parsed for entity extraction. In our case study, we came across a situation like this. The ts-common microservice has to be extracted manually in order to access all information within it. However, this can be mitigated by extracting the classes of fields present within other entities and extrapolating this to find the ts-common entities.

Data extraction for calls in our approach only extracts HTTP calls if they are made with the RestTemplate class. One way to improve extraction is to broaden the recognition of HTTP calls to other ways HTTP requests can be made, such as to HttpClient or HttpURLConnection libraries. Additionally, the REST call extraction can be improved by implementing detection of the pattern that we currently miss in Train Ticket, which is when there is conditional branching that determines what URL or part of the URL is to be passed or appended into the RestTemplate HTTP request. Though in train-ticket this pattern does not result in missed links between microservices, in other cases outside of train-ticket, if this pattern were encountered, there is a chance links could be missed if there are no other REST calls present in the source microservice to the same target microservice to still create the link.

There are limitations to what we are able to extract from the REST calls with our Graal IR approach. We are not able to determine the REST call body parameters types because we were unable to retrieve that information from the Graal IR. For path parameters, it is complicated to trace through the intricate tree to identify what may be path parameters included in the URLs of REST calls. Because we do not identify if there are path parameters we do not find their types. For these calculations, the act of traversing an AST would be beneficial because these high-level values are more easily identifiable compared to Graal IR. The inability to extract REST call body parameter types could be a result of our lacking expertise and knowledge of traversing Graal IR and using the Graal API to obtain information, rather than it being actually impossible to obtain.

The patterns our approach currently addresses are catered to that of the method structure, its code content, and the ways of making HTTP requests in train-ticket. A future improvement would be to address other common ways methods and calls may be executed and structured that may not be in train-ticket so that the same HTTP request information can still be extracted.

A restriction we encounter during REST call extraction is that we are not able to determine the REST call body parameters types, which is because the information obtained from the traversed Graal IR nodes only allowed us to detect if there were body parameters present. A second restriction is that it is very complicated to identify path parameters and the path parameter types. For path parameters, it is challenging to track through the tree to identify what in the URL path is actually a parameter versus just the path itself. Because we do not identify if there are path parameters, we do not find their types, which, while possible, would also be even more complex. For these calculations, the utilization of an AST could be beneficial because these high-level values are more easily identifiable compared to Graal IR.

When matching endpoints to REST calls in a system, it only matches the hard-coded part of the URI. Therefore, any unique information that separates two endpoints by path parameters could compromise the matching of a REST Call to an endpoint. This is a rare scenario as the endpoints would also have to have the same HTTP Method, and both have a body present. Another scenario similar to this is to have two endpoints, one with a path parameter in the middle of a URI and one that is hard-coded such that when the path parameter is filtered out it is the same as the URI. For example, if there is a URI with this structure/A/{B} /C and one with this structure/A/C the matching will cut out the parameter “B” therefore matching the same URI. Assuming they have the same HTTP method and have a body is taken into consideration as well.

The destination microservices are found by checking if the microservice name is in the hostname or in the URI path. However, in some cases that are not train-ticket, this might not work. Therefore, in more general approaches this might have to be disabled.

### 2) External Validity:

Our proof-of-concept has been evaluated on a single system benchmark and naturally might be biased to constructs utilized in this benchmark. We aimed to avoid this bias by targeting general constructs used in the Java Spring Framework. Thus, new systems might require adjustments in pattern matching. The intent of the case study was to demonstrate the feasibility of microservice-aware SAR on Native Images rather than to deliver a production-level solution. Custom extensions to the process to detect new patterns, new situations, and new frameworks are expected from community adoption. This is supported by open-sourcing our proof-of-concept.

To enable the reproducibility of this work, its assessment, and comparison with alternative works, we share our dataset of detected endpoints, REST calls, and entities in our case study. This can serve the scientific community in further advancements beyond the goals of this work.

An issue that our visualizer has pertains to older hardware, which can encounter performance issues if the provided microservices are excessive in size. As a result of these large microservices, it can be difficult to interact with the full context map and service dependency graph.

### VIII. Conclusion

With the current prevalence of microservice systems due to their cloud-friendly nature, it is important that they can be abstracted with important information accessible in a system-centric view in order to understand the system, identify issues, and maintain the system. Because of the size of most microservice-based projects, an automated and scalable solution is needed.

The described embodiments provide a microservice-aware SAR methodology utilizing recent advancements in improving microservice initialization times. GraalVM Native Image has been used to demonstrate the feasibility of the process and reliability of produced results when compared to a manual review of source code. Our proof-of-concept tool MicroGraal demonstrates that Native Images can be analyzed to produce two important architectural views for microservice systems, the service and domain views. In a case study using a third-party system, some of the described embodiments demonstrated promising results to build service dependency graphs and context maps that can assist practitioners in making informed decisions and act as the foundation for advancements in static analysis for microservice systems. Other embodiments enable the analysis of polyglot systems and broader analysis of other system benchmarks.

### A. Language-Agnostic Analysis of Microservice System Architecture

In some embodiments, the described frameworks for analyzing the architecture of a microservice system are implemented without requiring the underlying bytecode to have been originally written in Java, i.e., Graal IR is replaced with an alternate intermediate representation that is language-agnostic.

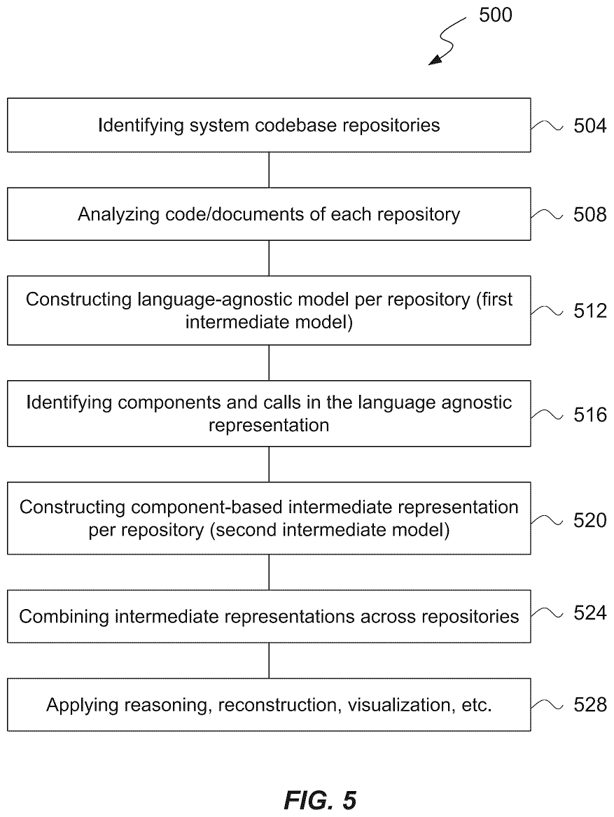

FIG. 5 is a flowchart of an example method 500 for transforming a codebase repository into a reconstructed software architecture. The method 500 may be implemented for a single code repository, or for multiple, and consider single, or multiple, platforms used to develop system parts (i.e., Java EE, Spring, Python Django, Go, NodeJS, C++). The method considers system parts that may encapsulate one or many data sources (i.e., database) interacting through API endpoints with other system parts or third-parties or listening to broker messages, thus processing synchronous or asynchronous requests.

For the software architecture reconstruction process to start, the system codebase (typically stored at code-repositories) is identified (504) and made accessible for processing, i.e., available through the file system, HTTP location, FTP, or similar. The process continues by analyzing each code repository (508). Code repositories contain system code, configuration files, build files, deployment descriptors, and similar. Based on the document type, appropriate analysis is applied.

In the case of source code, the abstract-syntax tree is built. In some embodiments, the assembled tree can be language agnostic (512). However, a different embodiment could consider platform-specific versions of these trees with platform-specific operations to follow. Other documents or artifacts can be used to augment the constructed tree or the provided context.

After the syntax tree is built, the components and higher-level constructs (such as remote calls) are identified (516) through parsing mechanism operating on the tree, detecting specific component type that matches the constructed tree elements (i.e., based on their metadata, naming conventions, inheritance, annotations, properties, etc.). In one embodiment, components like data entities, services, controllers, REST endpoints, repositories, and message sources and sinks are detected as well as remote calls. These components are identified along with their properties and metadata information (i.e., parameter constraints under which they operate).

Identified higher-level constructs (i.e., specific components) are integrated into a component-based intermediate representation (520) formed based on component inter-dependencies and calls. In one embodiment, the model can be constituted by markup descriptors through Extensible Markup Language (XML), JavaScript Object Notation (JSON), YAML, or others. The component-based intermediate representation contains information regarding dependencies to sources outside the codebase, i.e., other system parts, data sources, brokers, or third-party systems.

Upon processing multiple or all system repositories (508-520), the codebase component-based intermediate representations are combined (524). The combination can base on various strategies. These strategies include data schema overlap, remote call analysis, deployment, build, and configuration descriptors but are not exclusive to these.

For the data schema overlaps across system parts, the data entities tend to partially match across other system parts and correlate to some extent based on naming or attribute matches, etc. This is because system parts interact and exchange data that might have subviews from the perspectives of given system parts (also known as Bounded Context). The matches ban be based on graph similarity or text algorithms (i.e., Wu-Palmer). Entities that match are merged together to form an overlay data model for the combined system (also known as Context Map).

For the remote call analysis, endpoints, call methods, parameters, and signatures for calling sources are matched to other system parts and their analyzed REST endpoints. Other additional information can be considered, such as destinations or path fragments from configuration files (among many examples). Identified calls among system parts enable to derive a system overlay where the remote calls are merged into a holistic system. Data-flow analysis can be performed along this path, assessing the parameters, their origins, and sinks with respect to identified data entities.

For deployment, build and configuration descriptors, especially for containerized environments, these documents, which are part of code repositories, determine topological details of final system deployments, identify external data sources, brokers, communication channels, and systems or system parts. Derived information can determine topological overlay of system parts or augment overlays determined from alternative strategies.

The resulting overlay can be determined through various strategies (i.e., above examples) and could embed other information sources, such as manual intervention, rules, policies, or even information from previous system part versions or dynamic information related to system performance or dynamic characteristics.

Upon concluding the combined system overlay, other applications about the holistic system can be performed. Among examples can be automated or manual system reasoning, system verification, and testing, historical system analysis to identify architectural degradation, visualization of the system architecture in architectural views (528). Various embodiments include visual perspectives for different system stakeholders. These can use UML model, SysML, TOGAF, ArchiMate, augmented reality system representations, graph models, cone models, virtual reality models, etc.

The architecture reconstruction process 500 can be started manually; it can also be performed on various system versions considering source code repository versioning. The process can also be part of continuous system integration and continuous delivery, where it detects system anomalies across system versions. It can be part of service meshes, deployment infrastructure, tools for system management or monitoring, providing observable views to system developers, testers, architects, or system operations. Implementations can involve different programming languages or stick to a certain platform, and correspondingly, the language model can but does not have to be language agnostic and keep language specificity. Similarly, multiple language-specific implementations can exist for component identification.

### IX. Example Implementations and Embodiments

Implementations of the disclosed technology provide a rapid approximation of the cloud system architecture of microservice ecosystem. This approximated architecture can then be analyzed for efficiency, and bottlenecks, and provide causal and relatedness scores important to understand the limitations or weaknesses of the architecture. The main goal is to improve the understandability of the complete system.

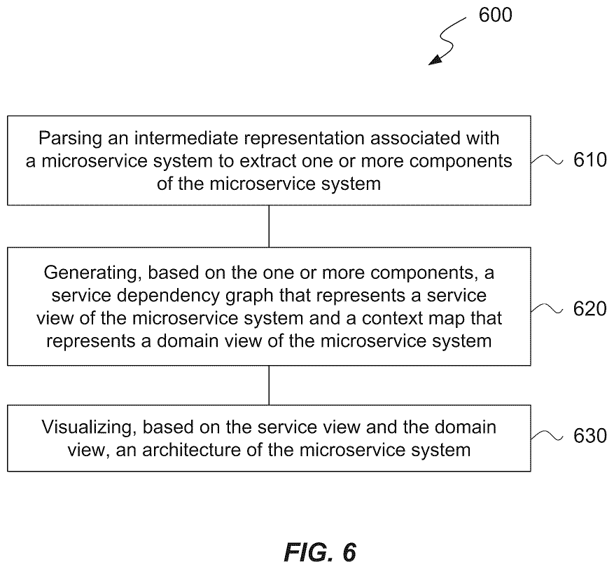

FIG. 6 illustrates a flowchart of an example method 600 for analyzing an architecture of a microservice system. As shown therein, the method 600 includes, at operation 610, parsing an intermediate representation associated with a microservice system to extract one or more components of the microservice system. In some embodiments, the intermediate representation is based on an analysis of a bytecode of the microservice system. In some embodiments, operation 610 corresponds to one or more operations illustrated in FIG. 2A.

The method 600 includes, at operation 620, generating, based on the one or more components, a service dependency graph (e.g., as illustrated in FIG. 3 for the Train-Ticket benchmark) that represents a service view of the microservice system and a context map (e.g., as illustrated in FIG. 4 for the Train-Ticket benchmark) that represents a domain view of the microservice system. In some embodiments, operation 620 corresponds to one or more operations illustrated in FIG. 2B.

The method 600 includes, at operation 630, visualizing, based on the service view and the domain view, an architecture of the microservice system. In some embodiments, operation 630 corresponds to one or more operations illustrated in FIG. 2C.

In some embodiments, the bytecode is configured to optimize a runtime performance of the microservice system based on a combination of points-to analysis, ahead-of-time (AOT) compilation, and class initialization at build time. Said another way, the disclosed embodiments use existing bytecode, which is normally used to optimize the runtime performance of a microservice system (e.g., lower memory footprint, etc.), in order to analyze the architecture of the microservice system.

In some embodiments, the method 600 includes generating, based on the analysis of the bytecode of the microservice system, the intermediate representation.

In some embodiments, the method 600 includes receiving, from a service or system external to the microservice system, the intermediate representation.

In some embodiments, the one or more components comprise at least one of an entity, a service, a controller, a remote Representational State Transfer (REST) call, or an endpoint of a microservice.

In some embodiments, one or more dependencies between the plurality of microservices is determined based on the remote REST call.

In some embodiments, the method 600 includes combining, prior to visualizing the architecture, one or more entities across the plurality of microservices based on a similarity in names and/or attributes of the plurality of microservices.

In some embodiments, in the service dependency graph, each node represents a microservice of the plurality of microservices, and a directed link between a first node and a second node represents a Representational State Transfer (REST) call from the first node to the second node.

In some embodiments, visualizing the architecture of the microservice system comprises displaying, upon the first node being selected, information about a corresponding microservice represented by the first node, wherein the information comprises at least one dependent and at least one dependency of the corresponding microservice.

In some embodiments, visualizing the architecture of the microservice system comprises displaying, upon the directed link being selected, information about a source microservice represented by the first node, a target microservice represented by the second node, and the REST call.

In some embodiments, the one or more components of the microservice system extracted from the intermediate representation comprises a plurality of entities, each entity comprises multiple attributes, and in the context map, each node represents an attribute of the multiple attributes, and a directed link between a first node and a second node represents an inclusion of a first attribute represented by the first node within a second attribute represented by the second node.

In some embodiments, visualizing the architecture of the microservice system comprises displaying, upon the directed link being selected, information comprising at least one multiplicity between the first node and the second node.

In some embodiments, the intermediate representation comprises a Graal Intermediate Representation (IR), and wherein generating the service dependency graph and the context map is based on using a Graal Virtual Machine (GraalVM).

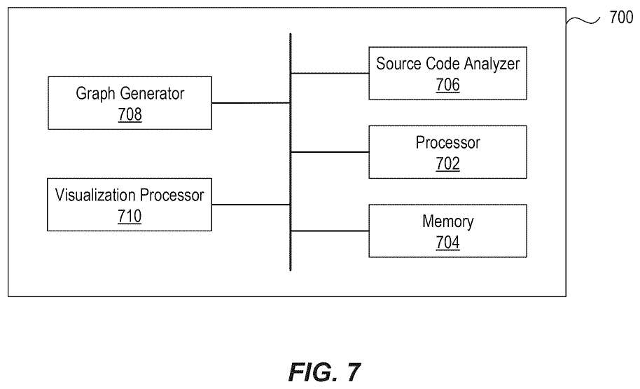

FIG. 7 shows an example of a hardware platform 700 that can be used to implement some of the techniques described in this patent document. For example, the hardware platform 700 may implement the various modules and algorithms described herein. The hardware platform 700 can include a processor 702 that can execute code to implement a method. The hardware platform 700 can include a memory 704 that is used to store processor-executable code and/or store data. The hardware platform 700 may further include a source code analyzer 706, a graph generator 708, and a visualization processor 710, each of which can communicate with the processor 702. In some embodiments, the processor 702 may include one or more processors implementing at least a portion (or the entirety) of the source code analyzer 706, the graph generator 708, and/or the visualization processor 710. The processor 702 may be configured to implement various functions associated with the described software architecture reconstruction (SAR) methods. In some embodiments, the memory 704 may include multiple memories, some of which are exclusively used by the processor 702 when implementing the source code analyzer 706, the graph generator 708, and/or the visualization processor 710.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A system for analyzing architectures of microservice systems, comprising:
a microservice system comprising a plurality of microservices that interact to perform an overall application function, each microservice of the plurality of microservices being associated with at least one endpoint and configured to perform a partial function of the overall application function, wherein the at least one endpoint of a corresponding microservice enables a user or another microservice to interact with the corresponding microservice; and
one or more processors configured to:
parse an intermediate representation to extract one or more components of the microservice system, wherein the intermediate representation is based on an analysis of a bytecode of the microservice system,
generate, based on the one or more components, a service dependency graph that represents a service view of the microservice system and a context map that represents a domain view of the microservice system, and
visualize, based on the service view and the domain view, an architecture of the microservice system.

2. The system of claim 1, wherein the bytecode is configured to optimize a runtime performance of the microservice system based on a combination of points-to analysis, ahead-of-time (AOT) compilation, and class initialization at build time.

3. The system of claim 1, wherein the one or more processors is configured to:
generate, based on the analysis of the bytecode of the microservice system, the intermediate representation.

4. The system of claim 1, wherein the one or more processors is configured to:
receive, from a service or system external to the microservice system, the intermediate representation.

5. The system of claim 1, wherein the one or more components comprise at least one of an entity, a service, a controller, a remote Representational State Transfer (REST) call, or an endpoint of a microservice.

6. The system of claim 5, wherein one or more dependencies between the plurality of microservices is determined based on the remote REST call.

7. The system of claim 1, wherein the one or more processors is configured to:
combine, prior to visualizing the architecture, one or more entities across the plurality of microservices based on a similarity in names and/or attributes of the plurality of microservices.

8. The system of claim 1, wherein, in the service dependency graph, each node represents a microservice of the plurality of microservices, and a directed link between a first node and a second node represents a Representational State Transfer (REST) call from the first node to the second node.

9. The system of claim 8, wherein visualizing the architecture of the microservice system comprises:
displaying, upon the first node being selected, information about a corresponding microservice represented by the first node, wherein the information comprises at least one dependent and at least one dependency of the corresponding microservice.

10. The system of claim 8, wherein visualizing the architecture of the microservice system comprises:
displaying, upon the directed link being selected, information about a source microservice represented by the first node, a target microservice represented by the second node, and the REST call.

11. The system of claim 1, wherein:
the one or more components of the microservice system extracted from the intermediate representation comprises a plurality of entities,
each entity comprises multiple attributes, and
in the context map, each node represents an attribute of the multiple attributes, and a directed link between a first node and a second node represents an inclusion of a first attribute represented by the first node within a second attribute represented by the second node.

12. The system of claim 11, wherein visualizing the architecture of the microservice system comprises:
displaying, upon the directed link being selected, information comprising at least one multiplicity between the first node and the second node.

13. The system of claim 1, wherein the intermediate representation comprises a Graal Intermediate Representation (IR), and wherein generating the service dependency graph and the context map is based on using a Graal Virtual Machine (GraalVM).

14. A method for analyzing architectures of microservice systems, comprising:
generating, based on an analysis of a bytecode of a microservice system, a graph-based intermediate representation that models control-flow and data-flow dependencies between a plurality of microservices of the microservice system;
parsing the graph-based intermediate representation to extract one or more components of the microservice system, wherein the one or more components comprise at least one of an entity, a service, a controller, a remote Representational State Transfer (REST) call, or an endpoint of one of the plurality of microservices;
generating, based on the one or more components and a list of attributes for each of the plurality of microservices, a service dependency graph that represents a service view of the microservice system and a context map that represents a domain view of the microservice system; and
visualizing, based on the service view and the domain view, an architecture of the microservice system.

15. The method of claim 14, wherein the bytecode is configured to optimize a runtime performance of the microservice system based on a combination of points-to analysis, ahead-of-time (AOT) compilation, and class initialization at build time.

16. The method of claim 14, comprising:
combining, prior to visualizing the architecture, one or more entities across the plurality of microservices based on a similarity in names and/or attributes of the plurality of microservices.

17. The method of claim 14, wherein, in the service dependency graph, each node represents a microservice of the plurality of microservices, and a directed link between a first node and a second node represents a REST call from the first node to the second node.

18. A non-transitory computer-readable storage medium having instructions stored thereupon for analyzing an architecture of a microservice system that includes a plurality of microservices, comprising:
instructions for parsing an intermediate representation to extract one or more components of the microservice system, wherein the intermediate representation is based on an analysis of a bytecode of the microservice system;
instructions for generating, based on the one or more components, a service dependency graph that represents a service view of the microservice system and a context map that represents a domain view of the microservice system; and
instructions for visualizing, based on the service view and the domain view, an architecture of the microservice system.

19. The non-transitory computer-readable storage medium of claim 18, wherein the one or more components comprise at least one of an entity, a service, a controller, a remote Representational State Transfer (REST) call, or an endpoint of a microservice, and wherein one or more dependencies between the plurality of microservices is determined based on the remote REST call.

20. The non-transitory computer-readable storage medium of claim 18, wherein, in the service dependency graph, each node represents a microservice of the plurality of microservices, and a directed link between a first node and a second node represents a Representational State Transfer (REST) call from the first node to the second node.
